(19) United States
(12) Patent Application Publication
(10) Pub. No.: US 2019/0001509 A1
(43) Pub. Date: Jan. 3, 2019

(54) WINDING STRUCTURE OF JOINT OF ROBOT AND ROBOT HAVING THE SAME

(71) Applicant: UBTECH Robotics Corp, Shenzhen (CN)

(72) Inventors: Youjun Xiong, Shenzhen (CN); Feng Hu, Shenzhen (CN); Xinpu Chen, Shenzhen (CN); Wenquan Shu, Shenzhen (CN)

(21) Appl. No.: 15/717,941

(22) Filed: Sep. 28, 2017

(30) Foreign Application Priority Data
Jul. 3, 2017 (CN) 201710531438.6

(51) Int. Cl. B25J 19/00; B65H 75/34

(52) U.S. Cl. CPC B25J 19/0029; B65H 75/34

(57) ABSTRACT

A winding structure of a joint of a robot includes a first servo, a second servo connected to the first servo, the second servo being rotatable with respect to the first servo, a flexible printed circuit board (FPCB) configured to connect the first servo to the second servo; and a winding assembly connected to the first servo. The winding assembly is used to wind the FPCB thereon.

### CROSS REFERENCE TO RELATED APPLICATIONS

This claims priority to Chinese Patent Application No. 201710531438.6, filed Jul. 3, 2017, which is hereby incorporated by reference herein as if set forth in its entirety.

### BACKGROUND

### 1. Technical Field

The present disclosure generally relates to robots, and particularly to a winding structure of a joint of a robot and a robot having the structure.

### 2. Description of Related Art

Robots can perform various actions by controlling servos at different joints. A humanoid robot usually includes a number of joints at the feet, the legs and the elbows. A joint usually includes a servo that serves as the driving component and is electrically connected to a controller or other servos via cables. For some conventional joints, the motion of the joints may cause too much tension in some of the cables. After long-term repeated operations, some of the cables may be damaged or even broken.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a winding structure according to one embodiment.

FIG. 2 is an isometric exploded view of the winding structure of FIG. 1, viewed from a first perspective.

FIG. 3 is an isometric exploded view of the winding structure of FIG. 1, viewed from a second perspective.

FIG. 4 is an isometric exploded view of the winding structure of FIG. 1 viewed from a third perspective.

FIG. 5 is an isometric exploded view of the winding structure of FIG. 1, viewed from a fourth perspective.

FIG. 6 is an enlarged view of portion A of FIG. 5.

FIG. 7 is an isometric view of a support of the winding disc of the winding structure of FIG. 1.

FIG. 8 is an isometric view of a ring of the winding disc of the winding structure of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

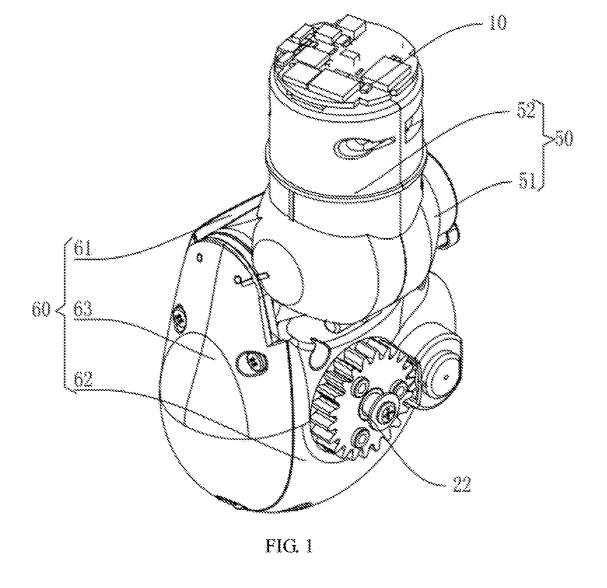

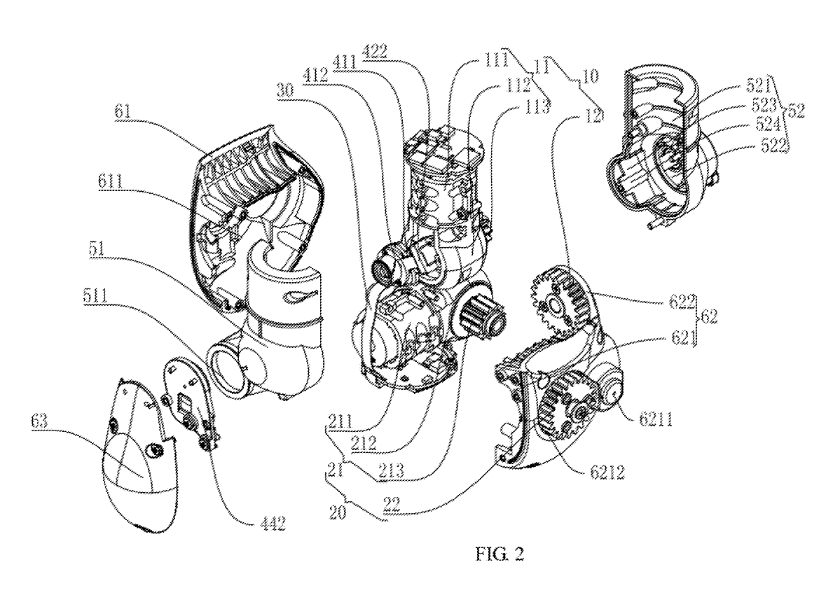

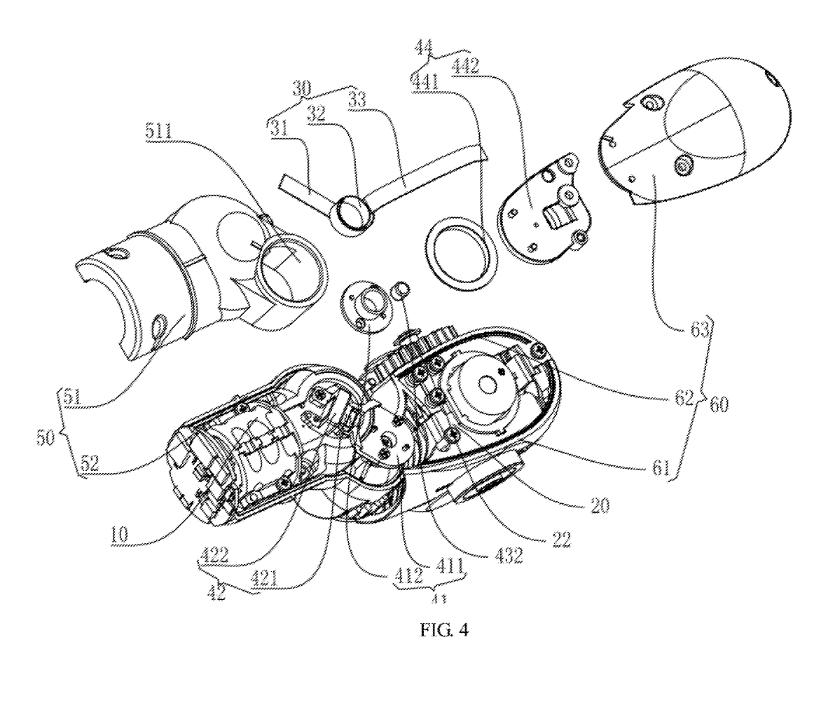

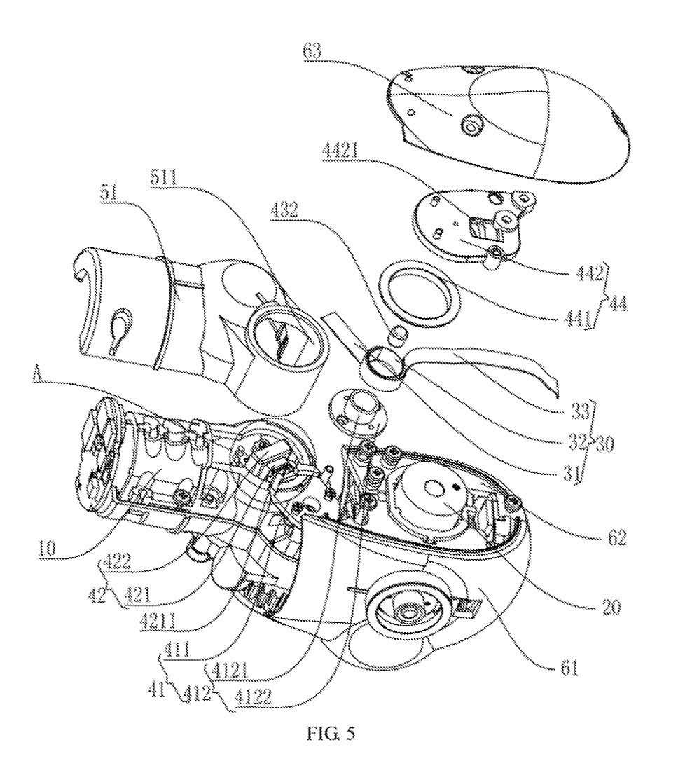

FIGS. 1-5 show a winding structure of a joint of a robot according to one embodiment. The winding structure includes a first servo 10, a second servo 20 that is connected to and rotatable with respect to the first servo 10, a flexible printed circuit board (FPCB) 30 for connecting the first servo 10 to the second servo 20, a winding assembly 40 arranged at the first servo 10, a first housing 50 for receiving the first servo 10 therein, and a second housing 60 for receiving the second servo 20 therein. The winding assembly 40 is used to wind the FPCB 30 thereon such that the occurrence of too much tension in the FPCB 30 when the second servo 20 rotates with respect to the first servo 10 is avoided, thereby protecting the FPCB 30. The winding structure can be applied in the limbs of a humanoid robot. In the embodiment, the first servo 10 corresponds to a hip bone joint of the robot, and the second servo 20 corresponds to a thigh joint of robot.

The FPCB 30 is fixed to the winding assembly 40, and at least a portion of the winding assembly 40 is fixed to the first servo 10. The FPCB 30 is electrically connected to the first servo 10. The FPCB 30 includes a roll portion 32, a first connection portion 31 and a second connection portion 33. The first connection portion 31 and the extension connection portion 33 are connected to the roll portion 32. Specifically, the first connection portion 31 may extend from the inner side of the roll portion 32, and the connection portion 33 may extend from the outer side of the roll portion. The roll portion 32 is arranged around the winding assembly 40. The first connection portion 31 is electrically connected to the first servo 10, and the second connection portion 33 is electrically connected to the second servo 20. With such configuration, the occurrence of too much tension in the FPCB 30 when the second servo 20 rotates with respect to the first servo 10 is avoided, thereby protecting the FPCB 30.

In the embodiment, the winding assembly 40 includes a winding disc 41, a fixing member 42, a positioning member 43 and a guiding member 44. The winding disc 41 is connected to the first servo 10 and used to wind the FPCB 30 thereon. That is, the roll portion 32 of the FPCB 30 is arranged around the winding disc 41. The fixing member 42 is fixed to the first servo 10 and used to fix one end of the FPCB 30 to the first servo 10. Specifically, the fixing member 42 fixes the first connection portion 31 of the FPCB to the first servo 10. By providing the winding disc 41 and the fixing member 42, the FPCB 30 can be wound on the winding disc 41 with one end extending to and electrically connected to the first servo 10. The positioning member 43 is used to connect the winding disc 41 to the first housing 50. The guiding member 44 is connected to the second servo 20 and used to guide the FPCB 30 or specifically the second connection portion 33 such that the occurrence of too much tension in the FPCB 30 when the second servo 20 rotates with respect to the first servo 10 is avoided.

The first servo 10 includes a main body 11, a circuit board (not shown) and a first external gear 12. The main body 11 includes a cylindrical portion 111, a spherical portion 112 having opposite sides and an output shaft 113 at one side of the spherical portion 112. The circuit board is arranged at the end of the cylindrical portion 111 that is away from the spherical portion 112. The first connection portion 31 of the FPCB 30 is connected to the circuit board. The external gear 12 is engaged with the output shaft 113. The side of the spherical portion 112 opposite the side where the output shaft 113 is located defines a receiving space 1122. A number of positioning posts 1123 protrude from the bottom of the receiving space 1122. The bottom further defines a number of positioning holes 1124. The positioning posts 1123 and the positioning holes 1124 are used to be engaged with other connection elements to fix a portion of the winding assembly 40 in the receiving space 1122.

The first housing 50 is used to protect the first servo 10 and can achieve the purpose of waterproof and dustproof. The first housing 50 includes a front housing half 51 and a rear housing half 52 at opposite sides of the first servo 10. The front housing half 51 and the second housing half 52 define corporately a closed receiving space for receiving the first servo 10. The from housing half 51 and the rear housing half 52 can be connected to each other by screws. It is noted that the term “front” corresponds to the direction in which the robot moves forward, and the term “back” corresponds to the direction in which the robot moves backward. In the embodiment, the first housing 50 includes a connection member 524 connected to the winding disc 41.

Specifically, the rear housing half 52 defines a first chamber 521 for receiving the cylindrical portion 111 of the first servo 10, a second chamber 522 extending from the lateral surface of the first chamber 521 and receiving the output shaft 113, and a third chamber 523 extending from the lateral surface of the third chamber 523. Correspondingly, the housing half 51 defines a fourth chamber (not shown) corresponding to the first chamber 521 for receiving the cylindrical portion 111, a fifth chamber (not shown) corresponding to the second chamber 522 which extends from the lateral surface of the fourth chamber and used for receiving the spherical portion 112, and a sixth chamber (not shown) corresponding to the third chamber 523 which extends from the lateral surface of the fifth chamber (not shown). The first chamber 521 and the fifth chamber corporately form a space for receiving the cylindrical potion 111. The second chamber 522 and the fifth chamber corporately form a space for receiving the spherical portion 112. The third chamber 523 and the sixth chamber corporately form a space for receiving the winding assembly 41. In the embodiment, the connection member 524 is located within the third chamber 523 and protrudes from the lateral surface of the first chamber 521. The connection member 524 defines a threaded hole in the top thereof. The connection member 524 mates with the winding disc 41 so as to fix the winding disc 41 to the rear housing half 52. The sixth chamber (also referred to as receiving hole 511) is used to receive the winding disc 41. The second connection portion 33 of the FPCB 30 passes through the receiving hole 511 and is then electrically connected to the second servo.

The second servo 20 includes a main body 21, a circuit board (not shown) and a second external gear 22. The main body 21 includes a cylindrical portion 211, a spherical portion 212 having opposite sides and an output shall 213 at one side of the spherical portion 112. The circuit board is arranged at the end of the cylindrical portion 211 that is away from the spherical portion 212. The second connection portion 333 of the FPCB 30 is connected to the circuit board. The external gear 22 is engaged with the output shaft 213.

The second housing 60 is used to protect the second servo 10 and can achieve the purpose of waterproof and dustproof. The second housing 60 includes a left housing portion, a right housing portion 62 and a front housing portion 63. The front housing half 51 and the second housing half 52 define corporately a closed receiving space for receiving the first servo 10. The left housing portion 61, the right housing portion 62 and the front housing portion 63 define corporately a closed receiving space for receiving the second servo 20.

The left housing portion 61 defines a seventh chamber 611 that is shaped and sized corresponding to a side of the second servo 20. The seventh chamber 611 is used to receiving the side of the second servo 20 without the output shaft 213. The right housing portion 62 defines n eighth chamber 621. A mounting plate 622 protrudes from one side of the right housing portion. The mounting plate 622 is substantially perpendicular to the right housing portion 62. The right housing portion 62 further defines a first accommodating hole 6211 that communicates with the eighth chamber 621 and is used to receive the output shaft 213, and a second accommodating hole that is located in a side opposite the side where the eighth chamber 621 is formed and used to receiving the external gear 22. The mounting plate 622 includes an inner side that faces the eighth chamber 621. The external gear 12 that is engaged with the output shaft 113 of the first servo is connected to the inner side of the mounting plate 622 so as to enable the right housing portion 62 to rotate as driven by the first servo 10. The front housing portion 63 defines a tenth chamber (not shown) for receiving the top of the cylindrical portion 211. The seventh chamber 611, the eighth chamber 621 and the tenth chamber corporately form the closed space for the receiving the second servo 20.

The winding disc 41 includes a support 411 and a ring 412. The support 411 is connected to the first servo 10. The ring 412 is connected to the support 411 and used to wind the FPCB 30 thereon. A portion of the support 411 is received in the receiving space 1122 and connected to the fixing member 42.

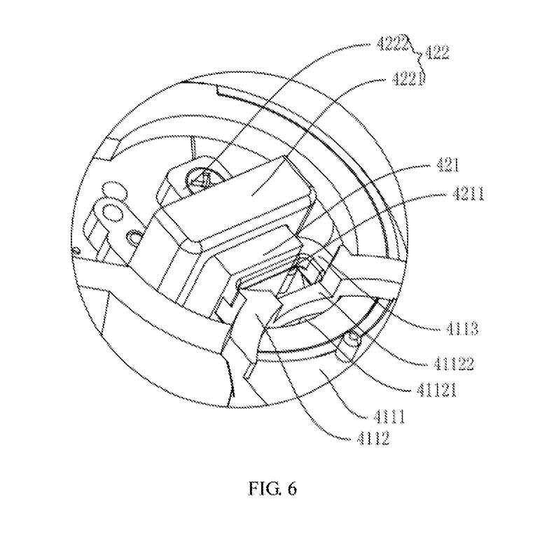

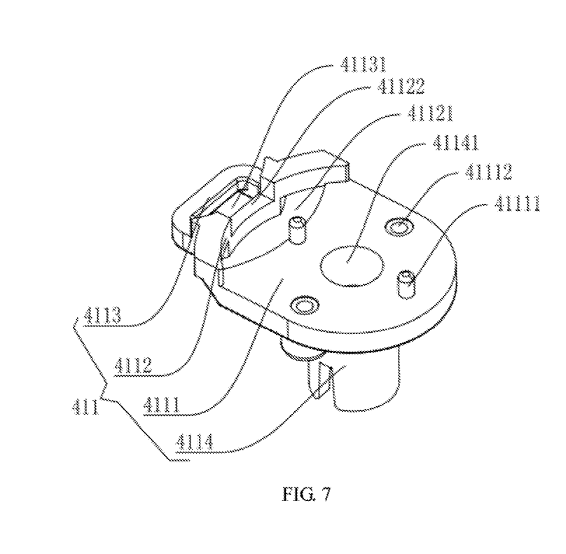

Referring to FIGS. 6 and 7, the support 411 includes a plate-shaped main body 4111, a limiting portion 4112 having two ends connected to a top of the main body 4111, a FPCB holding portion 4113 extending from a bottom of the limiting portion 4112 away from the main body 4111, and a mounting portion 4114 protruding from a bottom of the main body 4111. The main body 4111 defines a number of positioning posts 41111 and first connection holes 41112 for fixing the ring 412 of the winding disc 41. The mounting portion 4114 defines a through hole 41141. The positioning member 43 of the winding assembly 40 passes through the through hole 41141 and is fixed to the connection member 524 that is mated with the mounting portion 4114 so as to fix the support 411 to the first housing 50. The limiting portion 4112 is substantially arc-shaped. A gap 41121 is formed between the limiting portion 4112 and the main body 4111. The gap 41121 allows a rim 1121 of the receiving space 1122 of the first servo 10 to be fit therein. The limiting portion 4112 defines a recess 41122 that allows the FPCB 30 to pass therethrough. The FPCB holding portion 4113 defines a first through hole 41131 allowing the FPCB 30 to pass therethrough. After the roll portion 32 of the FPCB 30 is arranged around the ring 412, the first connection portion 31 of the FPCB 30 passes through the recess 41122 and the first through hole 41131 and is electrically connected to the first servo 10.

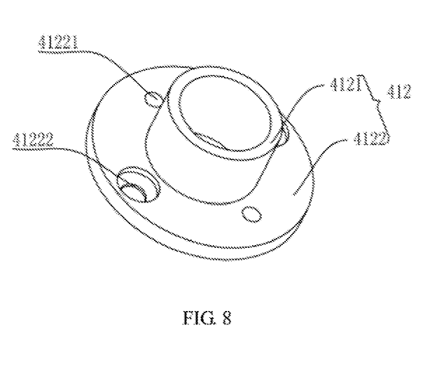

Retorting also to FIG. 8, the ring 412 includes a ring body 4121 and a flange 4122 extending radially and outwardly from a lateral surface of the ring body 4121 that allows the FPCB 30 to wind thereon. The flange 4122 is fixed to the support 411 of the winding disc 41. The flange 4122 includes limiting holes 41221 mated with the positioning posts 41111 and defines a number of second connection holes 41222 corresponding to the first connection holes 41112. When fixing the ring 412 to the support 411, the positioning posts 41111 are first inserted into the limiting holes 41221 and screws then pass through the first connection holes 41112 and the second connection holes 41222 so as to fix the ring 412 to the support 411.

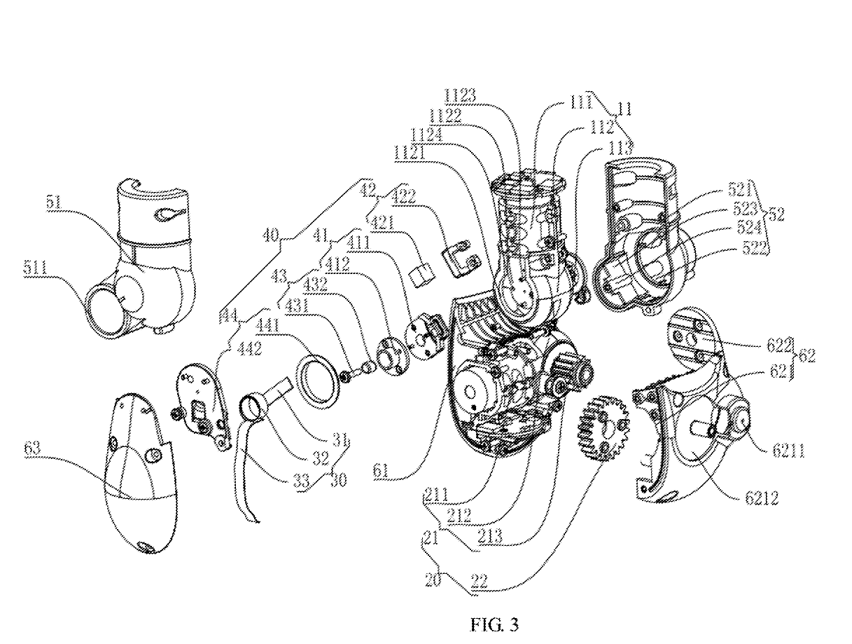

Referring to FIGS. 3-6, the fixing member 42 includes a connection block 421 and a fixing support 422. The connection block 421 is connected to the first servo 10 and used to press and holed the FPCB 30 within the receiving space 1122 of the first servo 10. The fixing support 422 is connected to the first servo 10 and used to fix the connection block 421 to the first servo 10. During assembly, the first connection portion 31 of the FPCB 30 is held within the receiving space 1122 by the connection block 421, and the connection block 421 is then fixed within the receiving space 1122 by the fixing support 422.

As shown in FIG. 6, the connection block 421 defines a receiving slot 4211 that is shaped and sized corresponding to the FPCB holding portion 4113. Specifically, the receiving slot 4211 has a height slightly greater than the thickness of the FPCB holding portion 4113 so as to receive the FPCB holding portion 4113 therein. The first connection portion 31 of the FPCB 30 passes through the first through hole 41131 and then passes through under the connection block 421 and is electrically connected to the first servo 10. The connection block 421 is fixed to the first servo 10 through the rising support 422 and presses the first connection portion 31 against the first servo 10. The FPCB 30 is thus protected.

The fixing support 422 includes a restriction portion 4221 and two connection portions 4222 extending perpendicularly from one end of the restriction portion 4221. The connection portion 4222 is fixed to the first servo 10. The restriction portion 4221 is substantially U-shaped and includes two parallel arms. The two connection portions 4222 respectively extend from the then ends of the two arms. In the embodiment, the two connection portions 4222 are fixed to the bottom of the receiving space 1122 of the servo 10 via screws. A number of positioning posts 1123 protrude from the bottom of the receiving space 1122. The bottom further defines a number of positioning holes 1124. The connection portions 4222 defines a number of first through holes corresponding to positioning posts 1123 and a number of second through holes corresponding to the poisoning holes 1124. During assembly, the positioning posts 1123 are first inserted into the first through holes and the fixing support 422 is then fixed within the receiving space 1122 by screws passing through the second through holes and the positioning holes 1124.

The positioning member 43 is connected to the winding disc 41 and is used to fix the winding disc 41 to the first housing 50 or specifically the connection member 524. The positioning member 43 includes a positioning element 432 and a positioning screw 431 milted with the positioning element 432. The positioning element 432 is received in the through hole 41141, and is tubular. The positioning screw 431 passes through the positioning element 432 and is engaged with the connection member 524. The positioning element 432 is sized and shaped according to the through hole 41141, and includes internal threads mated with the external threads of the positioning screw 431.

The guiding member 44 is connected to the second servo 20, and is mounted in the receiving hole 511. The guiding member 44 includes a positioning ring 441 and a servo mounting support 442. The positioning ring 441 is connected to the ring 412 of the winding disc 41 and received in the receiving hole 511, so as to allow the FPCB 30 to pass therethrough and press the roll portion 32 of the PFC 30. By providing the positioning ring 441, the movement of the FPCB 30 along the axial direction of the ring 412 is limited, which is conducive to avoiding the occurrence of to much tension in the FPCB 30 during the movement of the winding assembly. The servo mounting support 442 is connected to the second servo 20 and is located within the receiving hole 511 of the front housing half 51. The servo mounting support 442 defines a second through hole 4421 allowing the FPCB 30 or specifically the second connection portion 33 to pass therethrough.

The assembling of the winding assembly is simple. In the winding assembly, the FPCB 30 that connects the first servo 10 to the second servo 20 is wound around the winding assembly such that the occurrence of too much tension in the FPCB 30 when the second servo 20 rotates with respect to the first servo 10 is avoided, thereby improving the service life of the FPCB 30.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A winding structure of a joint of a robot, comprising:
a first servo;
a second servo connected to the first servo, the second servo being rotatable with respect to the first servo;
a flexible printed circuit board (FPCB) configured to connect the first servo to the second servo; and
a winding assembly connected to the first servo, the winding assembly being configured to wind the FPCB thereon.

2. The winding structure of claim 1, wherein the winding assembly comprises a winding disc and a fixing member, the winding disc is connected to the first servo and configured to wind the FPCB thereon, the fixing member is connected to the first servo and configured to fix one end of the FPCB to the first servo.

3. The winding structure of claim 2, wherein the winding disc comprises a support and a ring, the support is connected to the first servo, the ring is connected to the support and configured to wind the FPCB thereon.

4. The winding structure of claim 3, wherein the support comprises a main body, a limiting portion having two ends connected to a top of the main body, a FPCB holding portion extending a bottom of the limiting portion away from the main body, and a mounting portion protruding from a bottom of the main body, the FPCB holding portion defines a first through hole allowing the FPCB to pass therethrough, the ring comprises a ring body and a flange extending radially and outwardly from a lateral surface of the ring body, the flange is fixed to the main body.

5. The winding structure of claim 4 further comprising a first housing that receives the first servo therein, wherein the first housing comprises a connection member mating with the mounting portion, the winding assembly further comprises a positioning member that is configured to fix the winding disc to the connection member.

6. The winding structure of claim 5, wherein the mounting portion defines a mounting hole, the positioning member comprises a positioning element and a positioning screw, the positioning element is received in the mounting hole, and the positioning screw passes through the positioning element and is engaged with the connection member.

7. The winding structure of claim 2, wherein the fixing member comprises a connection block and a fixing support, the connection block is configured to press the FPCB to the first servo, the fixing support is connected to the first servo and configured to fix the connection block to the first servo.

8. The winding structure of claim 3 further comprising a first housing that receives the first servo therein, wherein the first housing defines a receiving hole for receiving the winding assembly, the winding assembly further comprises a guiding member connected to the second servo, the guiding member is mounted to the receiving hole and configured to guide the FPCB.

9. The winding structure of claim 8, wherein the guiding member comprises a positioning ring and a servo mounting support, the positioning ring is connected to the ring of the winding disc and received in the receiving hole, the servo mounting support is connected to the second servo and is located within the receiving hole, and the servo mounting support defines a second through hole allowing the FPCB to pass therethrough.

10. The winding structure of claim 1 further comprises a first housing that receives the first servo therein and a second housing that receives the second servo therein, wherein the first housing comprises a front housing half and a rear housing half, the front housing half and the second housing half define corporately a receiving space for receiving the first servo, the second housing comprises a left housing portion, a right housing portion and a front housing portion, the left housing portion, the right housing portion and the front housing portion define corporately an accommodating space for receiving the second servo.

11. The winding structure of claim 1, wherein the FPCB comprises a roll portion, a first connection portion and a second connection portion, the first connection portion and the extension connection portion are connected to the roll portion, the roll portion is arranged around the winding assembly, the first connection portion is connected to the first servo, and the second connection portion is connected to the second servo.

12. A robot comprising a winding structure, the winding structure comprising:
a first servo;
a second servo connected to the first servo, the second servo being rotatable with respect to the first servo;
a flexible printed circuit board (FPCB) configured to connect the first servo to the second servo; and
a winding assembly connected to the first servo, the winding assembly being configured to wind the FPCB thereon.
